(19) United States
(12) Patent Application Publication
(10) Pub. No.: US 2011/0051587 A1
(43) Pub. Date: Mar. 3, 2011

(54) Structure For Optical Pickup Head

(76) Inventors: Jinn-Kang Wang, Taipei (TW); Tsung-Min Yang, Hsinchu (TW); Chin-Sung Liu, Hsinchu (TW)

(21) Appl. No.: 12/546,689

(22) Filed: Aug. 25, 2009

(51) Int. Cl. G11B 7/00

(52) U.S. Cl. 369/112.23; G9B/7

(57) ABSTRACT

An optical pickup head is provided, including a laser diode set, an optical element set and an optical signal detector. The laser diode set is a laser light source capable of emitting single wavelength, two wavelengths or three wavelengths laser lights. Optical element set includes a low reflectivity beam-splitter and an objective lens. The low reflectivity beam-splitter has an average reflectivity ranging from 10% to 30%. After reflected twice by low reflectivity beam-splitter, the light fed back from recording medium to the laser diode set is reduced to avoid laser noise problem. Moreover, with the optical signal detector having a tilt θ ranging from 3° to 15° to optical axis, the optical signal detector can directly reflect the incident laser light into a different direction so that the reflected light will reduce the feedback light to the laser diode set.

### FIELD OF THE INVENTION

The present invention generally relates to a structure for optical pickup head, and more specifically to a structure for optical pickup head having a 10%-30% low reflectivity beam-splitter and moreover an optical signal detector with a 3° to 15° tilt to optical axis to reduce the laser feedback light.

### BACKGROUND OF THE INVENTION

The compact disc (CD), video compact disc (VCD) and digital versatile disc (DVD), High Density-DVD (HD-DVD) and BD-DVD are widely used in offices and households for information and/or entertainment. Therefore, the industry has been researching to develop more efficient optical pickup technology to improve the quality of the recording media, such as CD, VCD, DVD, HD-DVD and BD-DVD.

An optical pickup head reads or writes data on the recording media. In general, an optical pickup head employs a laser diode (LD) to emit an optical beam through an optical element set to focus on the surface of the recording media. An optical signal detector (PDIC) is used for receiving the optical signal and detecting the strength of the optical signal.

FIG. 1 shows a schematic view of a conventional optical pickup head. As shown in FIG. 1, an optical pickup head includes a recording medium 101, an optical signal detector 102, a laser diode set 103, a beam-splitter 104, a collimator lens 105 and an objective lens 106. The laser light of CD or DVD is emitted by laser diode set 103, passes a grating 104a, is reflected by beam-splitter 104, and then passes through collimator lens 105 and objective lens 106 to focus on the surface of recording medium 101 for reading or writing data. The laser light is then reflected by the surface of recording medium 101, passes through objective lens 106 and collimator lens 105, and is divided by beam-splitter 104 into two parts. One part passes through beam-splitter 104 to optical signal detector 102 for detecting the signal strength. The other part is reflected by beam-splitter 104, passes through grating 104a and feeds back to laser diode set 103, which causes laser diode set 103 relative intensity noise problem. The beam-splitter 104 of the optical pickup head usually has a higher reflectivity ranging from 35% to 85% to achieve higher objective lens output power from the beam-splitter first time reflection to write data on the disc, and to achieve better optical efficiency for the laser light on PDIC which is the beam-splitter reflection and transmission combination. However, the high reflectivity beam-splitter 104 will greatly increase the reflected light from recording medium 101 feed back to laser diode set 103, shown as line 42 of FIG. 3. Therefore, the laser will have strong noise problem. This is laser noise source 1 for laser diode set 103.

Similarly, reflected light 105c, 105d which are reflected by the surface of optical signal detector 102 may also pass through beam-splitter 104, collimator lens 105 and objective lens 106 to focus on the surface of recording medium 101 again, and the reflected light then passes through objective lens 106, collimator lens 105, is reflected again by beam-splitter 104 and feeds back to laser diode set 103 to cause laser noise problem. This is laser noise source 2 for laser diode set 103.

### SUMMARY OF THE INVENTION

The primary object of the present invention is to reduce or eliminate the noise problem for the laser diode caused by the feedback light of the recording medium.

To achieve the above object, the present invention provides an optical pickup head having a low reflectivity beam-splitter with an average reflectivity ranging from 10% to 30%. The optical pickup head includes a laser diode set, an optical element set and an optical signal detector. The laser light is emitted by the laser diode set, passes through and is reflected by the optical element set to focus on the surface of recording medium for data reading and writing. Then, the laser light is reflected by the surface of the recording medium, and is guided by the optical element set to the optical signal detector for detecting the signal strength. Because the optical signal detector has a 3° to 15° ranging θ tilt to the optical axis, the optical signal detector reflects the incident laser light to a direction out of optics axis so that the reflected light will reduce the feedback light to the optical element set and the light is reflected back again by the recording medium to the optical element set and the laser diode set.

The optical element set includes a low reflectivity beam-splitter, and an objective lens. The low reflectivity beam-splitter has the capability of both reflecting and transmitting the laser light. The objective lens is for focusing the laser light on the recording medium. The optical element set further includes a grating to split a light beam into three light beams. The optical element set also further includes a coupling lens to adjust the collimation of the laser beam and improve the optical efficiency. The low reflectivity beam-splitter of the present invention has the average reflectivity ranging from 10% to 30%, and reflects the laser light twice to reduce the aforementioned noise source 1 for laser diode set 103. Moreover, with the optical signal detector having an 3° to 15° ranging θ tilt to the optical axis to reduce the aforementioned noise source 2 for the laser diode set, the optical pickup head of the present invention can achieve the object of reducing or eliminating the noise problem of the laser diode caused by the feedback light from the recording medium.

The low reflectivity beam-splitter of the present invention is cost effective, and the optical signal detector having an 3° to 15° ranging θ tilt to the optical axis shows technological improvement. With one or the combination of the two features, the present invention can effectively reduce or eliminate the feedback light and solve the existing noise problem for the laser diode.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of a conventional optical pickup head;

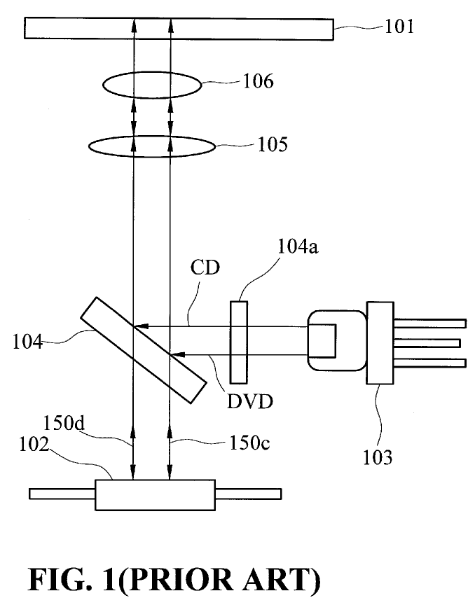

FIG. 2 shows a schematic view of an optical pickup head according to the present invention; and

FIG. 3 shows a schematic view of the optical efficiency of the low reflectivity beam-splitter of the present invention.

### DETAILED DESCRIPTION OF THE PREFERRED EMBODIMENTS

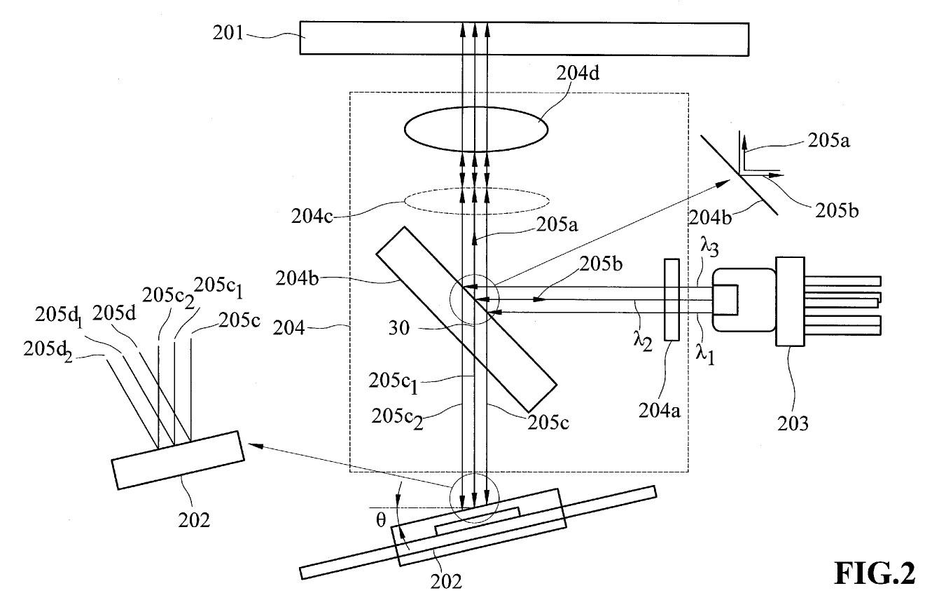

FIG. 2 shows a schematic view of an optical pickup head according to the present invention. As shown in FIG. 2, an optical pickup head includes a recording medium 201, an optical signal detector 202, a laser diode set 203, and an optical element set 204. Laser diode set 203 is a laser light source with single, two or three different wavelengths. Optical element set 204 includes a low reflectivity beam-splitter 204b and an objective lens 204d. Optical element set 204 may further include a grating 204a and a coupling lens 204c. Grating 204a is to split a light beam into three light beams. Coupling lens 204c is to adjust the collimation of the laser beam and improve the optical efficiency. Grating 204a and Coupling lens 204 can be added or removed as necessary.

Laser diode set 203 emits a laser light source λ1. Laser light source λ1 passes through grating 204a, and is reflected by low reflectivity beam-splitter 204b. The first-time reflected light 205a passes coupling lens 204c and objective lens 204d to focus on recording medium 201 for data reading and writing. The laser light reflected from recording medium 201 passes through objective lens 204d and coupling lens 204c is divided by low reflectivity beam-splitter 204b into reflection light and transmission light. The second-time reflected light 205b reflected by low reflectivity beam-splitter 204b feeds back to laser diode set 203. Because laser light source λ1 is reflected by low reflectivity beam-splitter 204b twice, low reflectivity second-time reflected light 205b will be much less than the light from a high reflectivity beam-splitter. Hence, when light 205b feeds back to laser diode, light 205b will not cause the laser noise problem. The same situation applies to laser light sources λ2 and λ3.

When recording medium 201 uses laser light source λ1 emitted by laser diode set 203 for data reading or writing, optical signal detector 202 receives reflected laser light 205c reflected by recording medium 201, and detects the signal strength of laser light 205c. Optical signal detector 202 is placed with a 3° to 15° ranging θ tilt to optical axis 30. Therefore, when laser light 205c arrives at optical signal detector 202, laser light 205c will be reflected by optical signal detector 202 with a specific angle into a reflected light 205d. Similarly, laser lights 205c1, 205c2 will be reflected by optical signal detector 202 into reflected lights 205d1, 205d2. With a tilt angle θ ranging from 3° to 15°, the tilt angle makes reflected lights 205d, 205d1, 205d2 deviated from the direction of the laser light source to effectively avoid the feedback of reflected lights 205d, 205d1, 205d2 to the laser light source and solve the laser feedback noise problem.

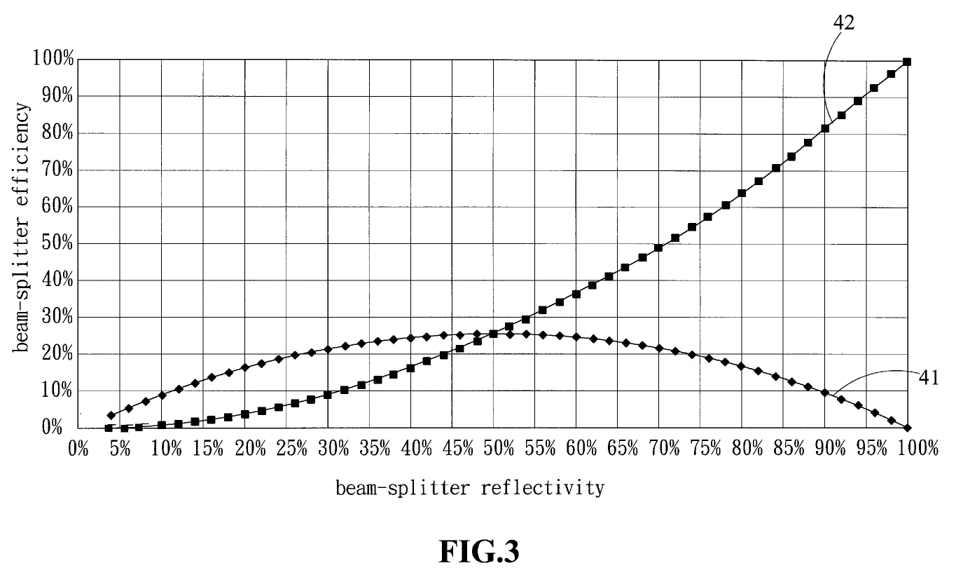

FIG. 3 shows a schematic view of the optical efficiency of the low reflectivity beam-splitter of the present invention. The X-axis of FIG. 3 shows the reflectivity (R) of the beam-splitter, which affects the light output power from the objective lens. Line 41 shows the total optical efficiency (R*T) of one-time reflection (R) and one-time transmission (T), which affects the light power on the optical signal detector. When the beam-splitter reflectivity is 50%, the total optical efficiency (R*T) will be maximum and reach 25%. Line 42 shows the optical efficiency of twice reflection (R*R), which affects the amount of disk feedback light to laser diode set. The efficiency of twice reflection (R*R) can reach 100% when the reflectivity (R) is 100%. At lower reflectivity, a much lower twice reflection can be obtained, that means less disk feedback light to laser diode set.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A structure of an optical pickup head, comprising:
a laser diode set, for emitting a plurality of laser lights;
an optical signal detector, for receiving and detecting signal strength of said plurality of laser lights; and
an optical element set, further comprising a low reflectivity beam-splitter and an objective lens;
wherein said laser light emitted from said laser diode set reflected by said low reflectivity beam-splitter into a first-time reflected light, and then passing through said objective lens to focus on a recording medium; and said first-time reflected light reflected by said recording medium, passing through said objective lens and reflected again by said low reflectivity beam-splitter into a second-time reflected light fed back to said laser diode set; light passing through said low reflectivity beam-splitter being guided to said optical signal detector for detecting signal strength of said laser light; said optical signal detector being placed with a tilt angle to optical axis, reflected light reflected by said optical signal detector being guided to a direction different from said laser light, and hence for reducing feedback light to said laser light of said laser diode set.

2. The structure of optical pickup head as claimed in claim 1, wherein said laser diode issues one, two or three types of lights with different wavelengths.

3. The structure of optical pickup head as claimed in claim 1, wherein said optical element set further comprises a grating between said laser diode set and said low reflectivity beam-splitter.

4. The structure of optical pickup head as claimed in claim 1, wherein said optical element set further comprises a coupler lens between said low reflectivity beam-splitter and said objective lens.

5. The structure of optical pickup head as claimed in claim 1, wherein said low reflectivity beam-splitter has a reflectivity ranging from 10% to 30%.

6. The structure of optical pickup head as claimed in claim 1, wherein said optical signal detector has a tilt angle ranging from 3° to 15° to said optical axis.

7. A structure of an optical pickup head, comprising:
a laser diode set, for emitting a plurality of laser lights;
an optical signal detector, for receiving and detecting signal strength of said plurality of laser lights; and
an optical element set, further comprising a reflectivity between 10%˜30% beam-splitter and an objective lens;
wherein said laser light emitted from said laser diode set reflected by said reflectivity between 10%˜30% beam-splitter into a first-time reflected light, and then passing through said objective lens to focus on a recording medium; and said first-time reflected light reflected by said recording medium, passing through said objective lens and reflected again by said reflectivity between 10%˜30% beam-splitter into a second-time reflected light fed back to said laser diode set; light passing through said reflectivity between 10%˜30% beam-splitter being guided to said optical signal detector for detecting signal strength of said laser light.

8. The structure for optical pickup head as claimed in claim 7, wherein said laser diode issues one, two or three types of lights with different wavelengths.

9. The structure for optical pickup head as claimed in claim 7, wherein said optical element set further comprises a grating between said laser diode set and said reflectivity between 10%˜30% beam-splitter.

10. The structure for optical pickup head as claimed in claim 7, wherein said optical element set further comprises a coupler lens between said reflectivity between 10%˜30% beam-splitter and said objective lens.
